(19) United States
(12) Patent Application Publication
(10) Pub. No.: US 2025/0066116 A1
(43) Pub. Date: Feb. 27, 2025

(54) WASTE CONTAINERS WITH ODOR SEALS

(71) Applicant: MUNCHKIN, INC., Van Nuys, CA (US)

(72) Inventors: Kevin Douglas Johnson, Tarzana, CA (US); Steven Bryan Dunn, Beverly Hills, CA (US)

(21) Appl. No.: 18/811,700

(22) Filed: Aug. 21, 2024

Related U.S. Application Data
(60) Provisional application No. 63/533,897, filed on Aug. 21, 2023.

(51) Int. Cl. B65F 1/16; B65F 1/06

(52) U.S. Cl. CPC B65F 1/1607; B65F 1/062; B65F 1/1646; B65F 2001/1676; B65F 2210/167; B65F 2240/132

(57) ABSTRACT

A waste container having an internal waste bag is disclosed having multiple lids and an odor controlling mechanism with planar sheets built into one of the lid assemblies, which prevents odors from within the internal waste bag from passing to the outside.

### CROSS REFERENCE TO RELATED APPLICATIONS

This application claims priority to U.S. Provisional Patent Application Ser. No. 63/533,897, filed Aug. 21, 2023, the content of which is hereby incorporated by reference herein in its entirety into this disclosure.

### TECHNICAL FIELD

The subject disclosure relates generally to containers. More particularly, the present disclosure relates to waste containers with internal odor seals.

### BACKGROUND

Most households possess at least one waste receptacle, while many households have multiple containers that hold or store waste therein. Diaper pails are specialized waste containers used by parents and other caregivers to temporarily store waste related to care of infants and young children. Soiled diapers are one of the most common articles of waste stored in diaper pails. Diapers, and waste more generally, often possess malodor and can exist in various states of decomposition, spoilage and decay. Waste can be a source of potentially harmful microorganisms such as bacteria, viruses, mold, fungus and other potentially harmful pathogens. Traditional waste receptacles thus present an environment for microorganisms to multiply, malodor to build and the process of decomposition to continue while the waste is stored therein.

### SUMMARY

The present subject disclosure describes various waste containers that have a built in mechanism to cut off, seal, and/or separate an internal chamber that holds soiled material from an outside environment, which may be in close proximity to adults, children, and infants. The mechanism allows a user to insert a soiled diaper into a designated waste bag and have the bag automatically pinch off its open end so that the odor and potential harmful pathogens are automatically contained within the waste bag with no further manual or automated intervention required. This passive sealing process is designed to be simple, efficient, and cost-effective.

In one exemplary embodiment, the present subject disclosure is a diaper pail. The diaper pail includes a housing; and a lid assembly attached to the housing, the lid assembly having: a first lid that allows access to an interior of a flexible bag assembly housed within the housing; a second lid that allows access to a top structure of the flexible bag assembly housed within the housing; and a third lid cartridge that accommodates the flexible bag assembly; and a pair of planar sheets that overlap with each other and pinch a portion of a bag formed by the flexible bag assembly.

In another exemplary embodiment, the present subject disclosure is a diaper pail. The diaper pail includes a housing having an upper end and a lower end; and a lid assembly attached by a first hinge to the upper end, the lid assembly having: a first lid that allows access to an interior of a flexible bag assembly housed within the housing; a second lid that is pivotally attached to the first lid by a second hinge and allows access to a top structure of the flexible bag assembly housed within the housing; a third lid cartridge that accommodates the flexible bag assembly; and a pair of planar sheets secured in a circular frame positioned within the third lid cartridge, such that the planar sheets overlap with each other and pinch a portion of a bag formed by the flexible bag assembly.

In yet another exemplary embodiment, the present subject disclosure is a diaper pail. The diaper pail includes a housing having an upper end and a lower end; and a lid assembly attached by a first hinge to the upper end, the lid assembly having: a first lid that allows access to an interior of a flexible bag assembly housed within the housing; a second lid that is pivotally attached to the first lid by a hinge and allows access to a top structure of the flexible bag assembly housed within the housing; a third lid cartridge that accommodates the flexible bag assembly; and a pair of planar sheets positioned within the third lid cartridge that overlap with each other such that one of the planar sheets is partially positioned below the other planar sheet such that the planar sheets pinch a portion of a bag formed by the flexible bag assembly.

### BRIEF DESCRIPTION OF THE DRAWINGS

Various exemplary embodiments of this disclosure will be described in detail, wherein like reference numerals refer to identical or similar components or steps. The accompanying drawings, which are incorporated in and constitute a part of this specification, illustrate embodiments of the subject disclosure and technical data supporting those embodiments, and together with the written description, serve to explain certain principles of the subject disclosure. With reference to the following figures, wherein:

FIG. 1 is a front perspective view of a container, according to an exemplary embodiment of the present subject disclosure.

FIG. 2 is a front view of a container, according to an exemplary embodiment of the present subject disclosure.

FIG. 3 is a front cross-sectional view of a container, according to an exemplary embodiment of the present subject disclosure.

FIG. 4 is a back view of a container, according to an exemplary embodiment of the present subject disclosure.

FIG. 5 is a side view of a container, according to an exemplary embodiment of the present subject disclosure.

FIG. 6 is a side cross-sectional view of a container, according to an exemplary embodiment of the present subject disclosure.

FIG. 7 is a top view of a container, according to an exemplary embodiment of the present subject disclosure.

FIG. 8 is a bottom view of a container, according to an exemplary embodiment of the present subject disclosure.

FIG. 9 is a front perspective view of a container with a first lid open, according to an exemplary embodiment of the present subject disclosure.

FIG. 10 is a front perspective view of a container with a first lid open and a cassette positioned within the container, according to an exemplary embodiment of the present subject disclosure.

FIG. 11 is a side view of a container with a first lid open, according to an exemplary embodiment of the present subject disclosure.

FIG. 12 is a side cross-sectional view of a container with a first lid open, according to an exemplary embodiment of the present subject disclosure.

FIG. 13 is a top view of a container with a first lid open, according to an exemplary embodiment of the present subject disclosure.

FIG. 14 is a front perspective view of a container with a first lid open and second lid partially open, according to an exemplary embodiment of the present subject disclosure.

FIG. 15 is a front view of a container with a first lid open and second lid partially open, according to an exemplary embodiment of the present subject disclosure.

FIG. 16 is a back view of a container with a first lid open and second lid partially open, according to an exemplary embodiment of the present subject disclosure.

FIG. 17 is a top view of a container with a first lid open and second lid partially open and a cassette positioned within the container, according to an exemplary embodiment of the present subject disclosure.

FIG. 18 is a front perspective view of a container with a first lid open and second lid open, according to an exemplary embodiment of the present subject disclosure.

FIG. 19 is a side view of a container with a first lid open and second lid open, according to an exemplary embodiment of the present subject disclosure.

FIG. 20 is a side cross-sectional view of a container with a first lid open and second lid open, according to an exemplary embodiment of the present subject disclosure.

FIG. 21 is a top view of a container with a first lid open and second lid open, according to an exemplary embodiment of the present subject disclosure.

FIG. 22 is a top view of a container with a first lid open and second lid open and a cassette positioned within the container, according to an exemplary embodiment of the present subject disclosure.

FIG. 23 is a top view of a container with a first lid open and second lid open and a single use bag positioned within the container, according to an exemplary embodiment of the present subject disclosure.

FIG. 24 is a front cross-sectional view of a container with a first lid open and second lid open, according to an exemplary embodiment of the present subject disclosure.

FIG. 25 is a front cross-sectional view of a container with a first lid open and second lid open and a cassette positioned within the container, according to an exemplary embodiment of the present subject disclosure.

FIG. 26 is a front cross-sectional view of a container with a first lid open and second lid open and a single use bag positioned within the container, according to an exemplary embodiment of the present subject disclosure.

FIG. 27 is a front perspective view of a container with a lid assembly open, according to an exemplary embodiment of the present subject disclosure.

FIG. 28 is a side view of a container with a lid assembly open, according to an exemplary embodiment of the present subject disclosure.

FIG. 29 is a front view of a container with a lid assembly open, according to an exemplary embodiment of the present subject disclosure.

FIG. 30 is a top view of a container with a lid assembly open, according to an exemplary embodiment of the present subject disclosure.

FIG. 31 is a top perspective view of a third lid cartridge, according to an exemplary embodiment of the present subject disclosure.

FIG. 32 is a bottom perspective view of a third lid cartridge, according to an exemplary embodiment of the present subject disclosure.

FIG. 33 is a side view of a third lid cartridge, according to an exemplary embodiment of the present subject disclosure.

FIG. 34 is a top view of a third lid cartridge, according to an exemplary embodiment of the present subject disclosure.

FIG. 35 is a front cross-sectional view of a cassette positioned atop a third lid cartridge, according to an exemplary embodiment of the present subject disclosure.

FIG. 36 is a front cross-sectional view of a cassette positioned atop a third lid cartridge within a container, according to an exemplary embodiment of the present subject disclosure.

FIG. 37 is an exploded top perspective view of a third lid cartridge, according to an exemplary embodiment of the present subject disclosure.

FIG. 38 is an exploded top perspective view of a third lid cartridge with optional ring plate, according to an exemplary embodiment of the present subject disclosure.

FIG. 39 is an exploded bottom perspective view of a third lid cartridge, according to an exemplary embodiment of the present subject disclosure.

FIG. 40 is an exploded bottom perspective view of a third lid cartridge with optional ring plate, according to an exemplary embodiment of the present subject disclosure.

FIG. 41 is an exploded top perspective view of a third lid cartridge positioned atop a container, according to an exemplary embodiment of the present subject disclosure.

FIG. 42 is an exploded top perspective view of a third lid cartridge with optional ring plate positioned atop a container, according to an exemplary embodiment of the present subject disclosure.

FIG. 43 is a top perspective view of two planar sheets, according to an exemplary embodiment of the present subject disclosure.

FIG. 44 is a top view of two planar sheets, according to an exemplary embodiment of the present subject disclosure.

FIG. 45 is a bottom perspective view of two planar sheets, according to an exemplary embodiment of the present subject disclosure.

FIG. 46 is a side view of two planar sheets, according to an exemplary embodiment of the present subject disclosure.

FIG. 47 is a front top perspective view of a cassette, according to an exemplary embodiment of the present subject disclosure.

FIG. 48 is a front bottom perspective view of a cassette, according to an exemplary embodiment of the present subject disclosure.

FIG. 49 is a cross-sectional view of a cassette, according to an exemplary embodiment of the present subject disclosure.

FIG. 50 is a cross-sectional view of a cassette within a container, according to an exemplary embodiment of the present subject disclosure.

FIG. 51 is a cross-sectional view of a cassette within a container with extended bag holding soiled material, according to an exemplary embodiment of the present subject disclosure.

FIG. 52 is an enlarged cross-sectional view of a cassette within a container, according to an exemplary embodiment of the present subject disclosure.

FIG. 53 is a cross-sectional view of a single use bag within a container with extended bag holding soiled material, according to an exemplary embodiment of the present subject disclosure.

FIG. 54 is an enlarged cross-sectional view of a single use bag within a container, according to an exemplary embodiment of the present subject disclosure.

FIG. 55 is a front perspective view of a container with a first lid open and second lid partially open, according to another exemplary embodiment of the present subject disclosure.

FIG. 56 is a side cross-sectional view of a container, according to another exemplary embodiment of the present subject disclosure.

FIG. 57 is a side cross-sectional view of a container with a first lid open, according to another exemplary embodiment of the present subject disclosure.

FIG. 58 is an enlarged cross-sectional view of a lid assembly within a container, according to another exemplary embodiment of the present subject disclosure.

### DETAILED DESCRIPTION

The following detailed description references specific embodiments of the subject disclosure and accompanying figures, including the respective best modes for carrying out each embodiment. It shall be understood that these illustrations are by way of example and not by way of limitation. Particular embodiments of a bottle warmer will now be described in greater detail with reference to the figures.

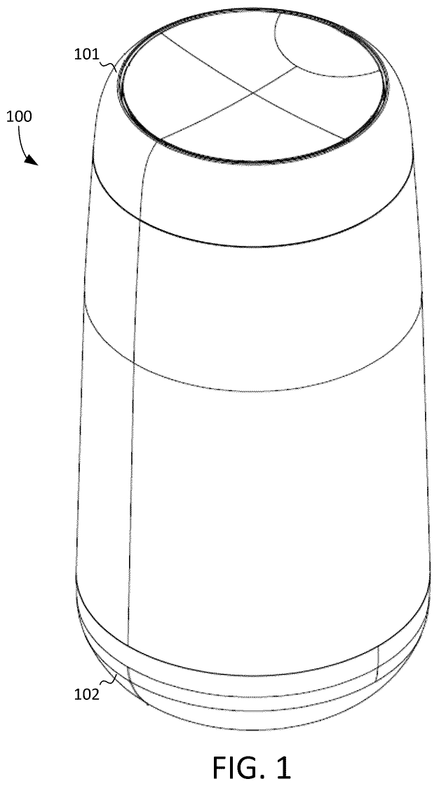

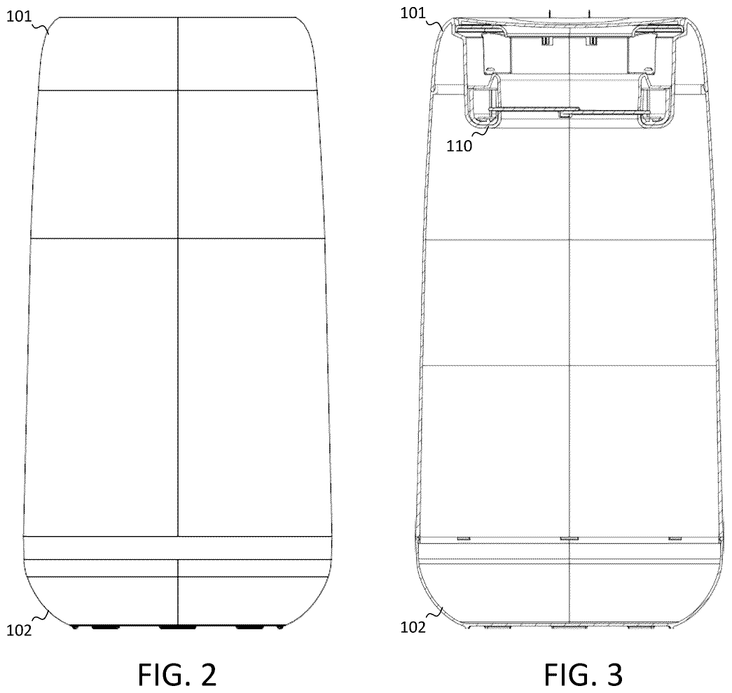

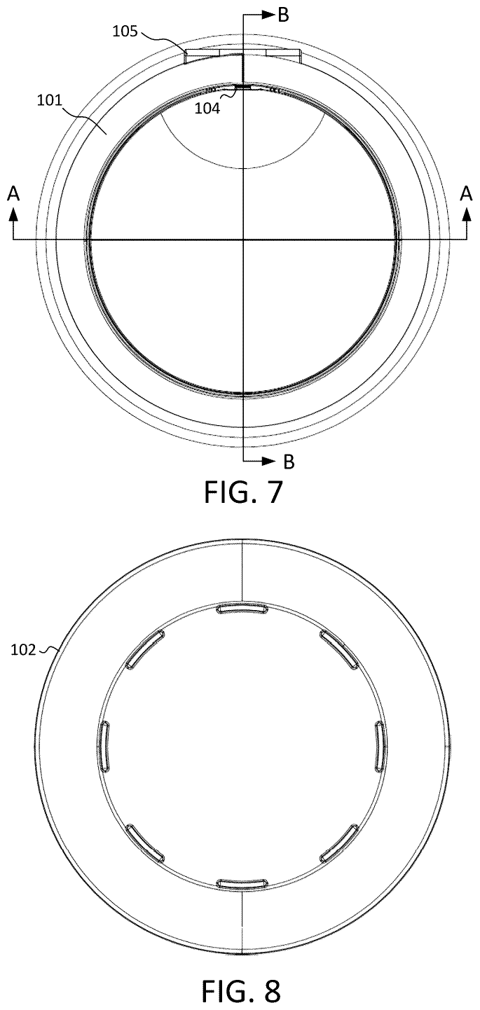

FIG. 1 shows a perspective view of a waste container 100 according to the present subject disclosure. The container is shown as a cylindrical housing with a top end 101 and a bottom end 102, but can take any shape. The container 100 has smooth outer edges and surfaces. FIG. 2 shows a front view and FIG. 3 shows a cross-sectional view of the container 100 along plane A-A (of the top view shown in FIG. 7). As shown in FIG. 3, container 100 includes a lid assembly 110 having three separate and independent lids, each pivotably independent, as described in more detail below.

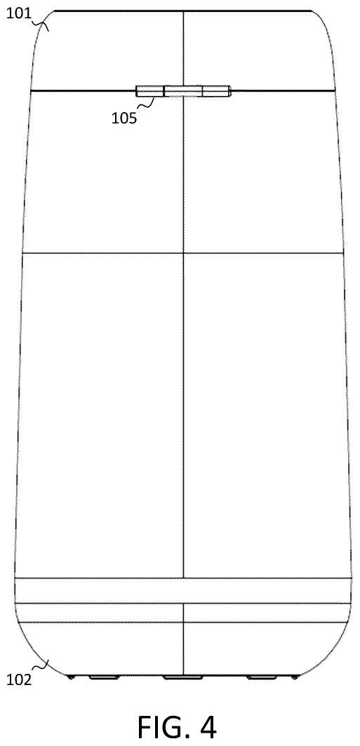

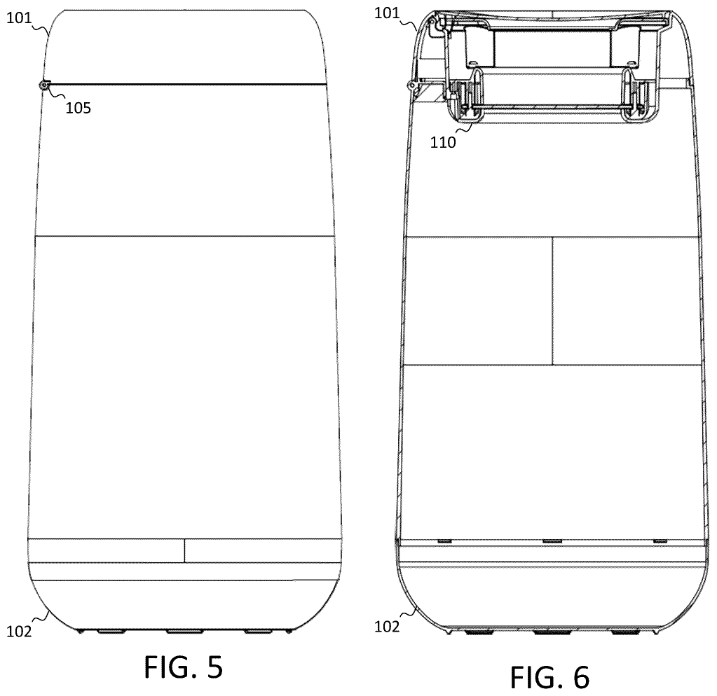

FIG. 4 shows a back view and FIG. 5 shows a side view of container 100. External hinge 105 allows the opening of the lid assembly 110. FIG. 6 shows a cross-sectional view of the container 100 along plane B-B (of the top view shown in FIG. 7), including a cross-sectional view of the lid assembly 110.

FIG. 7 shows a top view and FIG. 8 shows a bottom view of container 100. External hinge 105 allows the opening of the lid assembly 110.

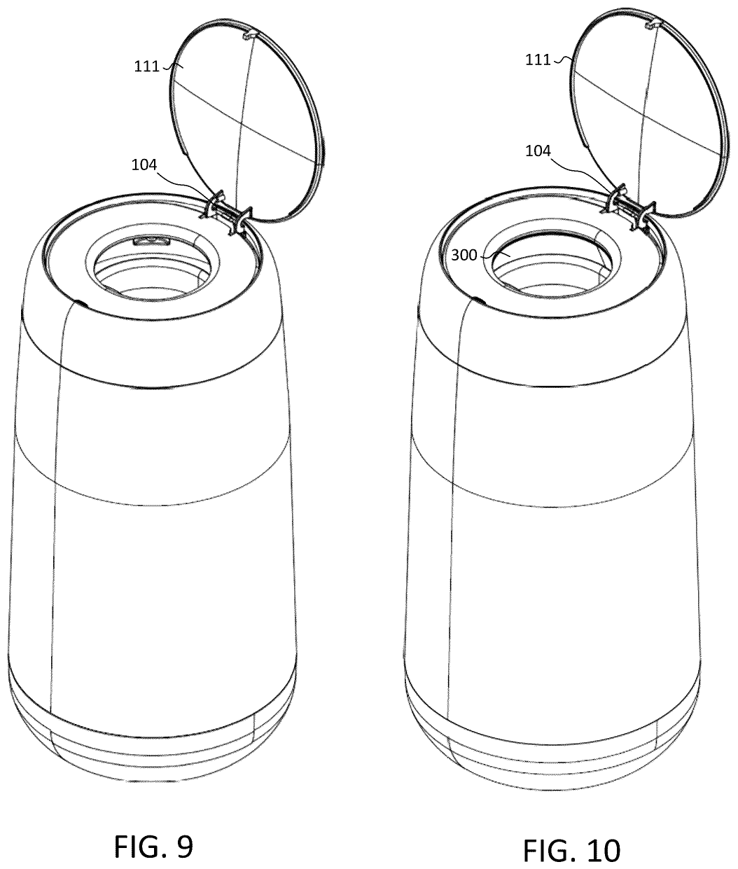

FIGS. 9-10 show perspective views of the container 100 with a raised first lid 111. FIG. 9 shows an internal view of container 100, and FIG. 10 shows an internal view showing a cassette 300 positioned within container 100. Internal hinge 104 is hidden from an external view of the container, and allows the opening and closing of the first lid 111.

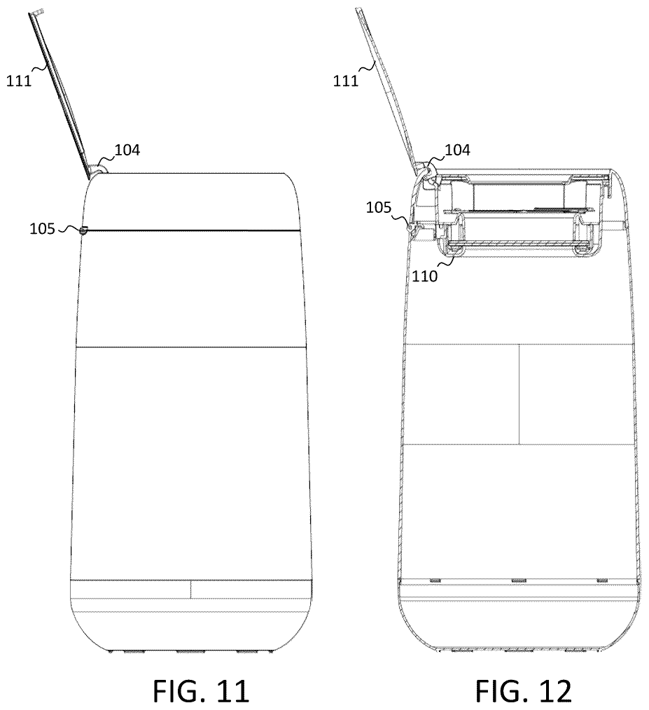

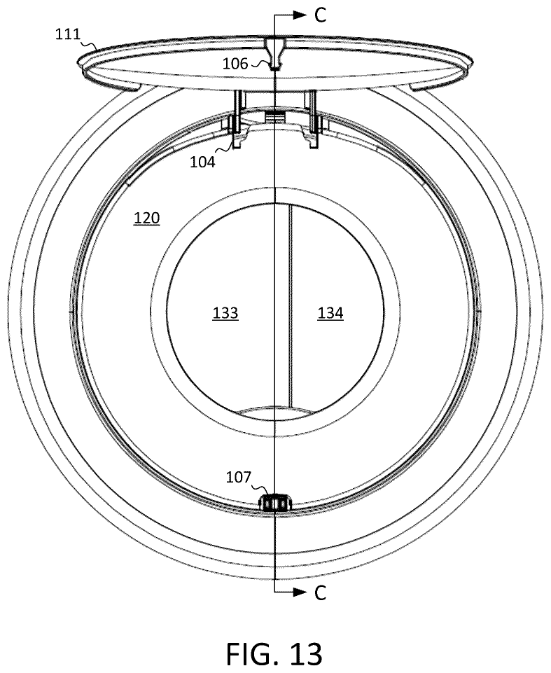

FIG. 11 shows a side view of container 100 with a raised first lid 111. FIG. 12 shows a cross-sectional view of container 100 along plane C-C (of the top view shown FIG. 13) with a raised first lid 111. FIG. 13 shows a top view of container 100 with a raised first lid 111, and a second lid 120 in position within the lid assembly 110. As shown in FIGS. 11-12, internal hinge 104 is positioned inside container 100 and allows the rotation of the first lid 111, and external hinge 105 is positioned mostly on the outside of container 100 and allows the rotation of the lid assembly 110 as a whole.

As shown in FIG. 13 and other drawings, the closing mechanism of the first lid 111 is through a snap and release spring mechanism with a projection end 106 and a mating receiving end 107. The details have not been shown but would be appreciated by one having ordinary skill in the art. Other closing mechanisms are also possible and within the purview of the present subject disclosure.

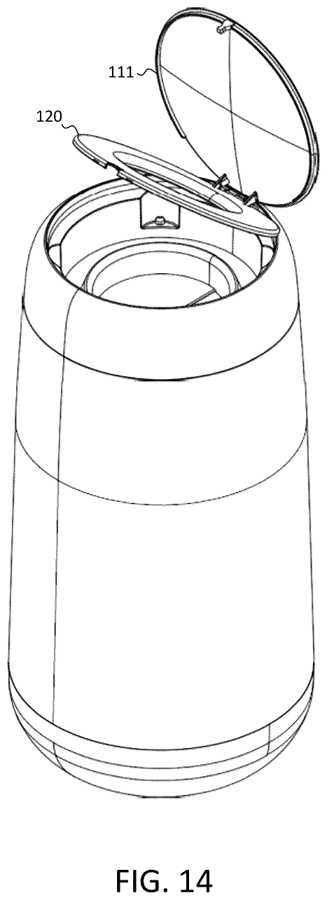

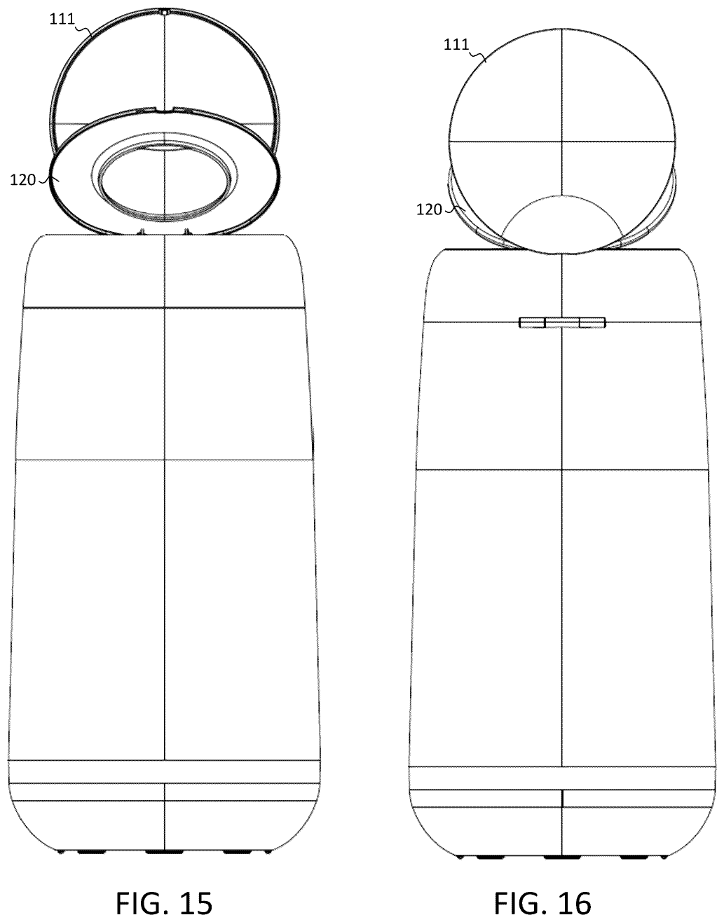

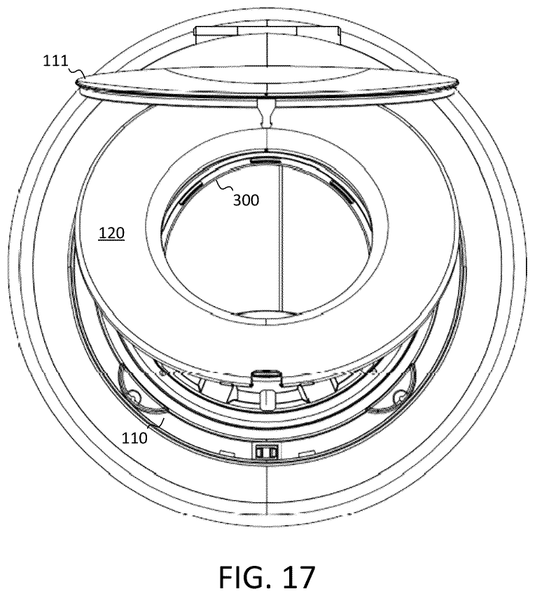

FIG. 14 shows a perspective view of container 100 with a raised first lid 111 and a partially raised second lid 120. FIGS. 15 and 16 show front and back views, respectively, of container 100 with a raised first lid 111 and a partially raised second lid 120. FIG. 17 shows a top view of container 100 with a raised first lid 111 and a partially raised second lid 120. A cassette 300 is positioned within the lid assembly 110.

It should be noted that container 100, cassette 300, and single use bag assembly 400, as described in this disclosure, are similar in function and interaction (but different in structure as shown in the figures) to the ones shown and described in Applicant's co-pending applications, U.S. patent application Ser. No. 17/165,890, entitled, “Container for Receiving Multiple Flexible Bag Assemblies,” and U.S. patent application Ser. No. 17/338,628, entitled, “Ultraviolet Light Sterilizing Waste Containers,” and U.S. patent application Ser. No. 17/889,367, entitled, “Cassette for Dispensing Pleated Tubing,” all of which are incorporated by reference herein in their entirety into this disclosure. As used herein and throughout this disclosure, a flexible bag assembly will mean, a cassette containing a flexible bag, a single use bag, or the like.

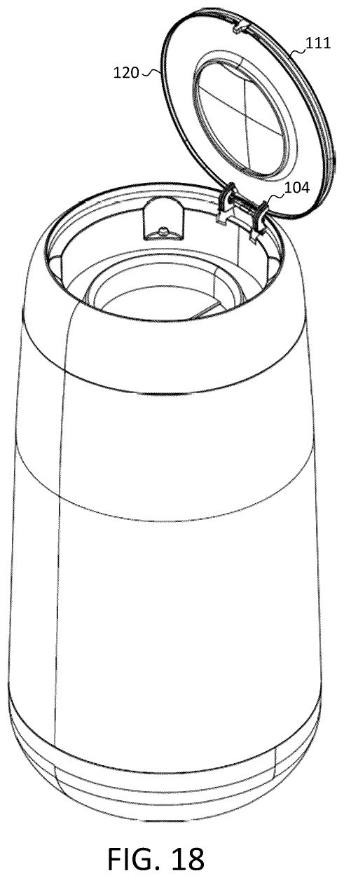

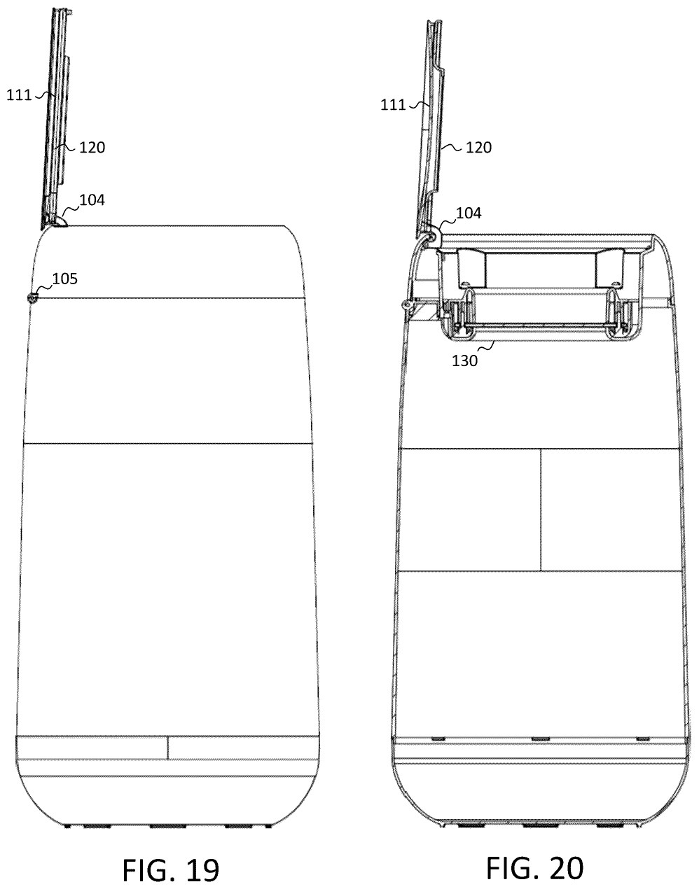

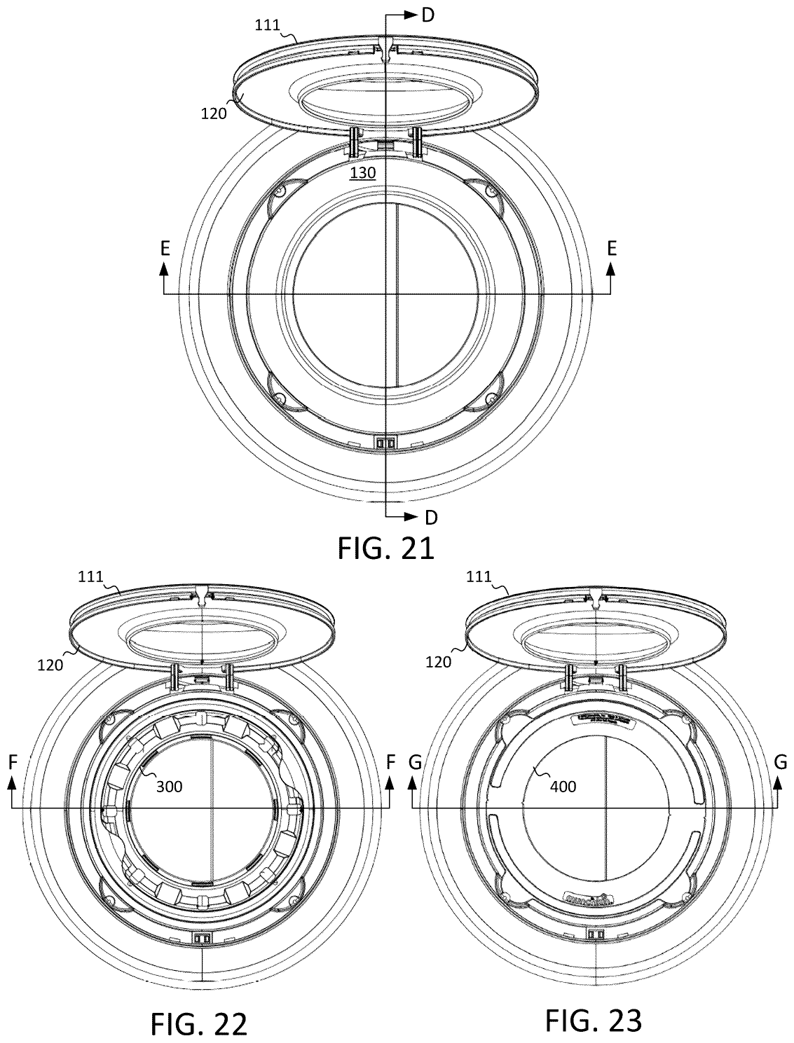

FIG. 18 shows a perspective view of container 100 with raised first lid 111 and second lid 120. FIG. 19 shows a side view of container 100 with a raised first lid 111 and second lid 120. FIG. 20 shows a cross-sectional view of container 100 along plane D-D (of the top view shown FIG. 21) with raised first lid 111 and second lid 120, and a cross-sectional view of the third lid cartridge 130 in position. The first lid 111 and second lid 120 rotate about a shared internal hinge 104.

FIG. 21 shows a top view of container 100 with raised first lid 111 and second lid 120, and downward view of third lid cartridge 130. FIG. 22 shows a top view of container 100 with raised first lid 111 and second lid 120, and downward view of a cassette 300 in position on the third lid cartridge 130. FIG. 23 shows a top view of container 100 with raised first lid 111 and second lid 120, and downward view of a single bag holder 400 in position on the third lid cartridge 130.

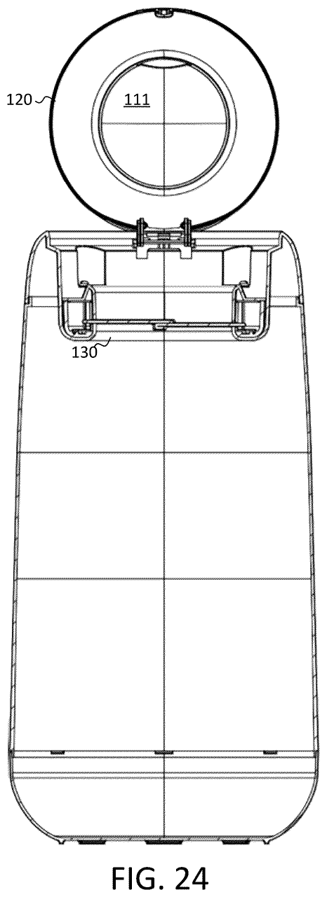

FIG. 24 shows a cross-sectional view of a container 100 along plane E-E (of the top view shown FIG. 21) with a raised first lid 111 and second lid 120, and a cross-sectional view of the third lid cartridge 130 in position.

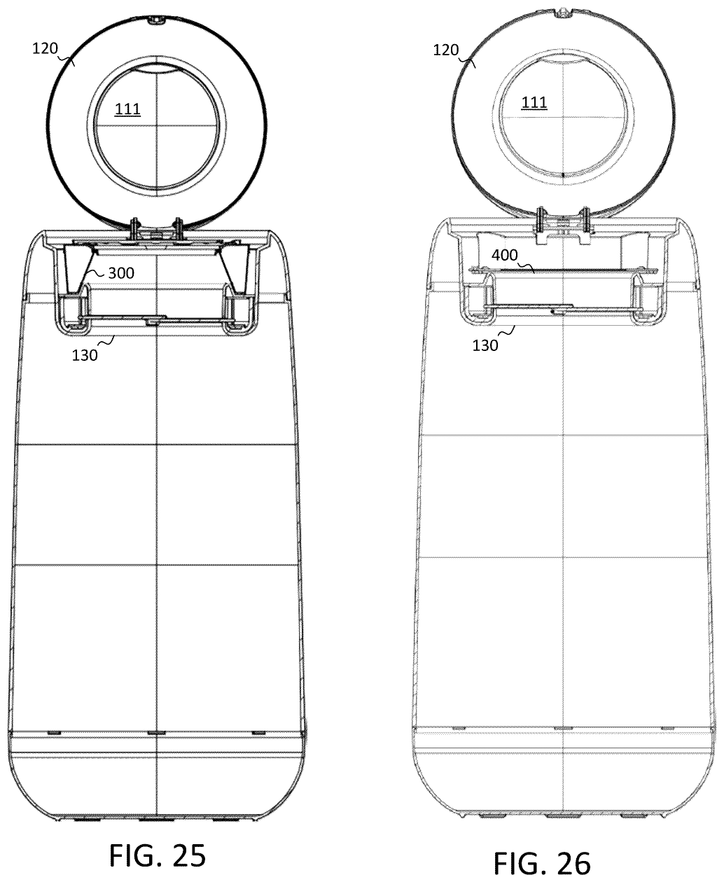

FIG. 25 shows a cross-sectional view of a container 100 along plane F-F (of the top view shown FIG. 22) with a raised first lid 111 and second lid 120, and a cross-sectional view of the cassette 300 positioned on the third lid cartridge 130.

FIG. 26 shows a cross-sectional view of a container 100 along plane G-G (of the top view shown FIG. 23) with a raised first lid 111 and second lid 120, and a cross-sectional view of the single bag holder 400 positioned on the third lid cartridge 130.

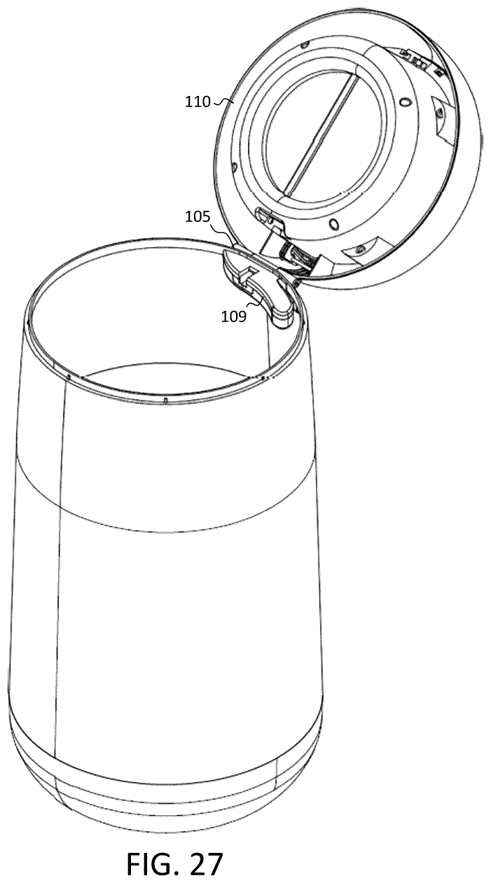

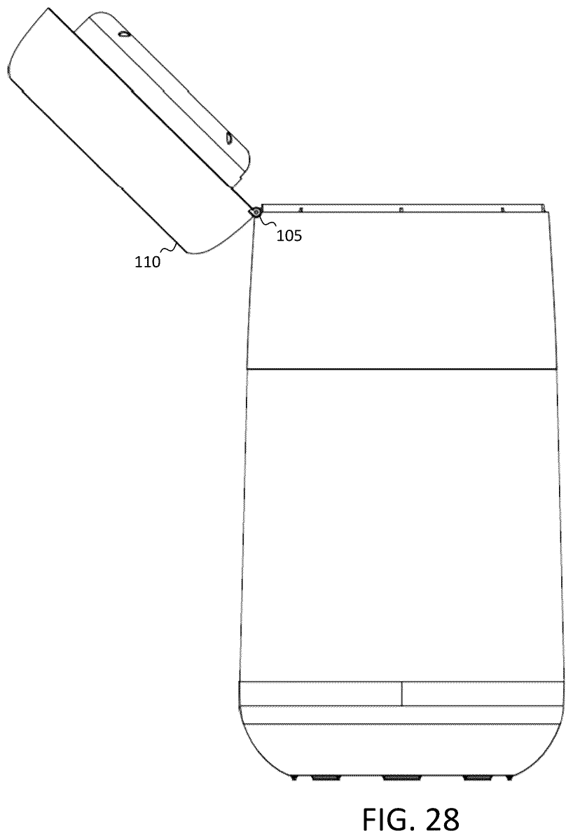

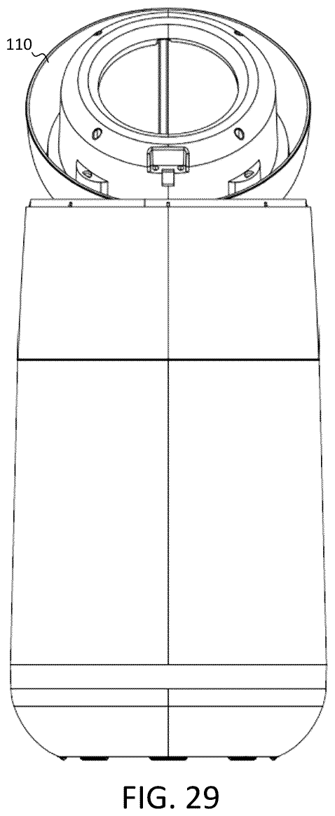

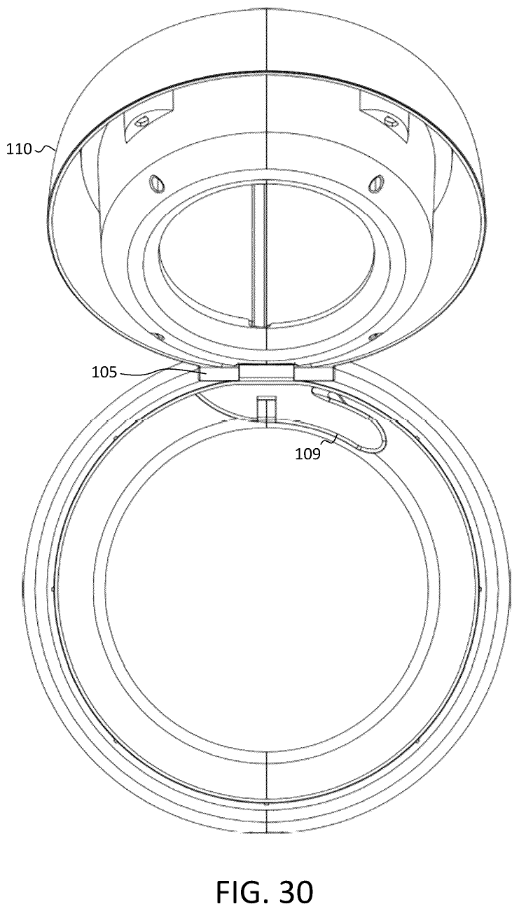

FIG. 27 shows a perspective view of container 100 with raised lid assembly 110. FIG. 28 shows a side view of container 100 with raised lid assembly 110. FIG. 29 shows a front view of container 100 with raised lid assembly 110. FIG. 30 shows a top view of container 100 with raised lid assembly 110. As shown in FIGS. 27-30, lid assembly 110 rotates about hinge 105. An internally placed cutter 109 assists in cutting the top end of a plastic sheet from the cassette 300. The user may then knot the freshly cut top end of the open bag, and then discard it. The user then knots the bottom end of a new bag, which is formed by pulling down the sheet from cassette 300.

As shown in the figures (see for example FIG. 19), a first hinge 104 is used to rotate the first lid 111 and second lid 120, and a second hinge 105 is used to rotate the entire hinge assembly 110 (which includes first lid 111, second lid 120, and third lid cartridge 130).

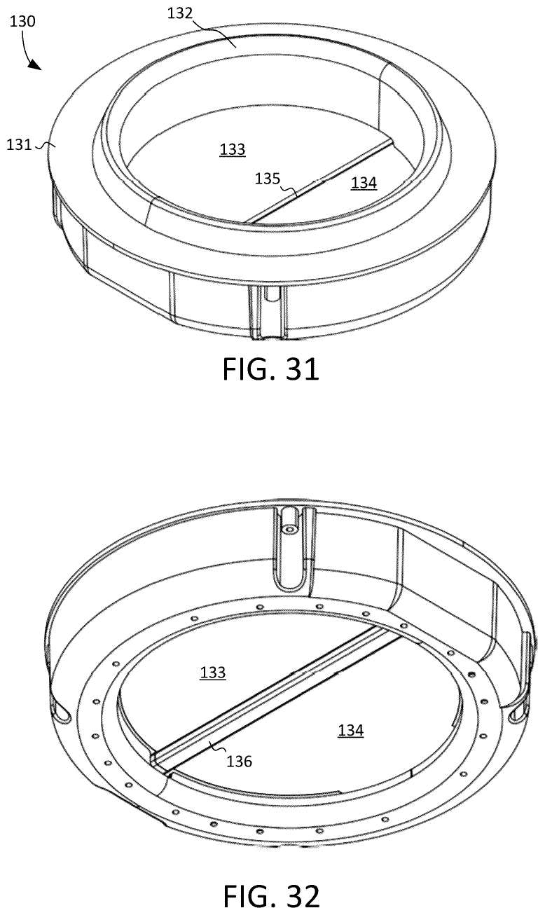

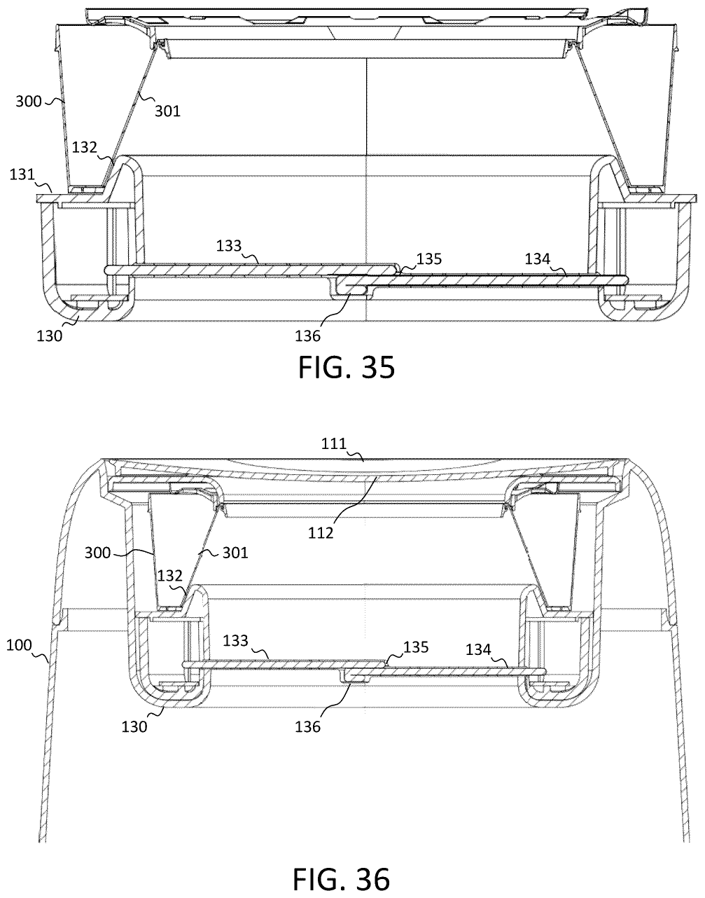

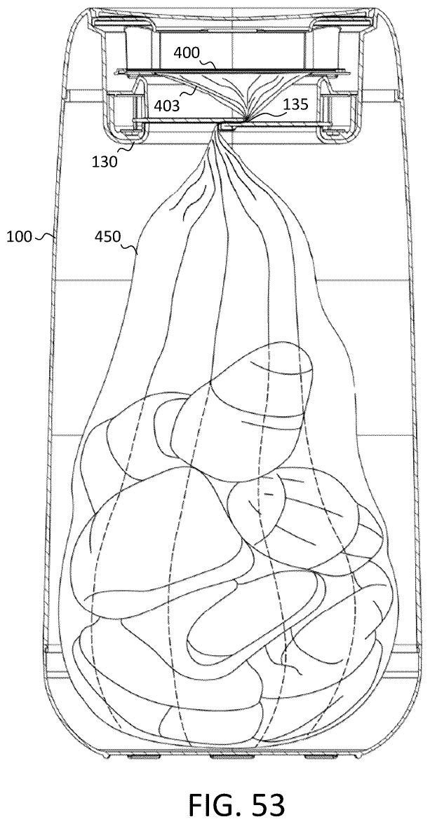

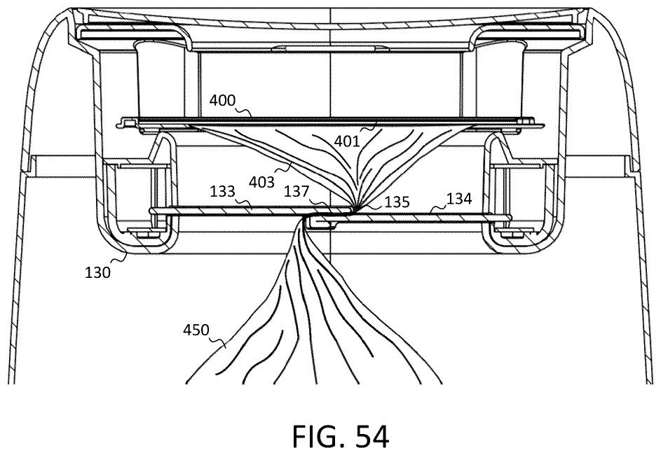

FIGS. 31-34 show various views of the third lid cartridge 130. The third lid cartridge 130 serves multiple purposes. One function is to secure a sheet or single bag thereon, such as cassette 300, as shown in FIGS. 35-36, or single use bag 400, as shown in FIGS. 53-54. Another function of lid cartridge 130 is to create an odor barrier between the interior of the bag inside of the container 100 and the environment outside of the container 100. The design of the third lid cartridge 130 is similar to a bowl or saucer, with an outer rim 131, which surrounds an inner vertical wall 132. Within the inner vertical wall 132 are a pair of nonplanar sheets 133 and 134, which overlap at linear gap portion 135. The third lid cartridge 130 may be modular and replaceable so that a user may decide to replace the third lid cartridge 130 as needed after it has been worn out from repeated use or has broken.

FIG. 35 shows a cross-sectional view of a cassette 300 positioned atop the third lid cartridge 130. A bottom portion of the cassette 300 is positioned atop the outer rim 131 of the third lid cartridge 130. Further, the inner sloped wall 301 of the cassette 300 is angled such that its bottom portion mates with the outer angled portion of the vertical wall 132 of the third lid cartridge 130. The inner sloped wall 301 encircles and slides upon the outer angled portion of vertical wall 132. This contact creates secure and stable cradling of the cassette 300 between the second lid 112 and third lid cartridge 130, as shown in FIG. 36.

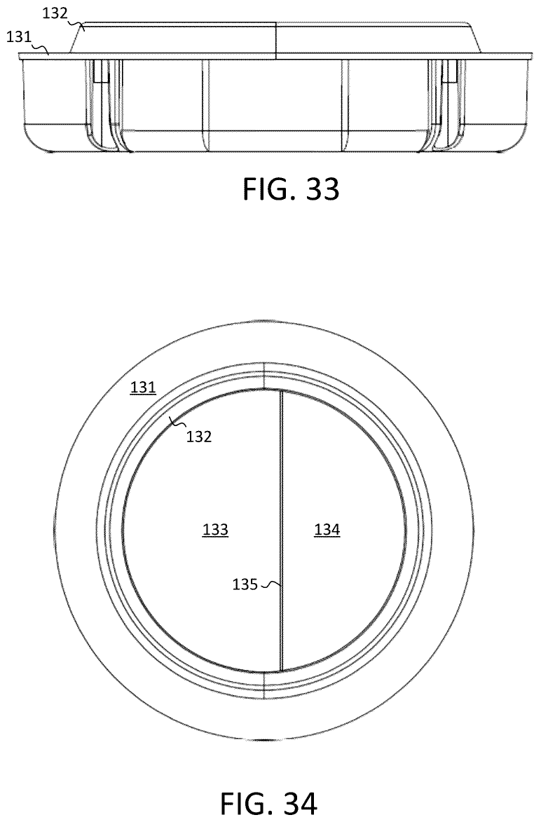

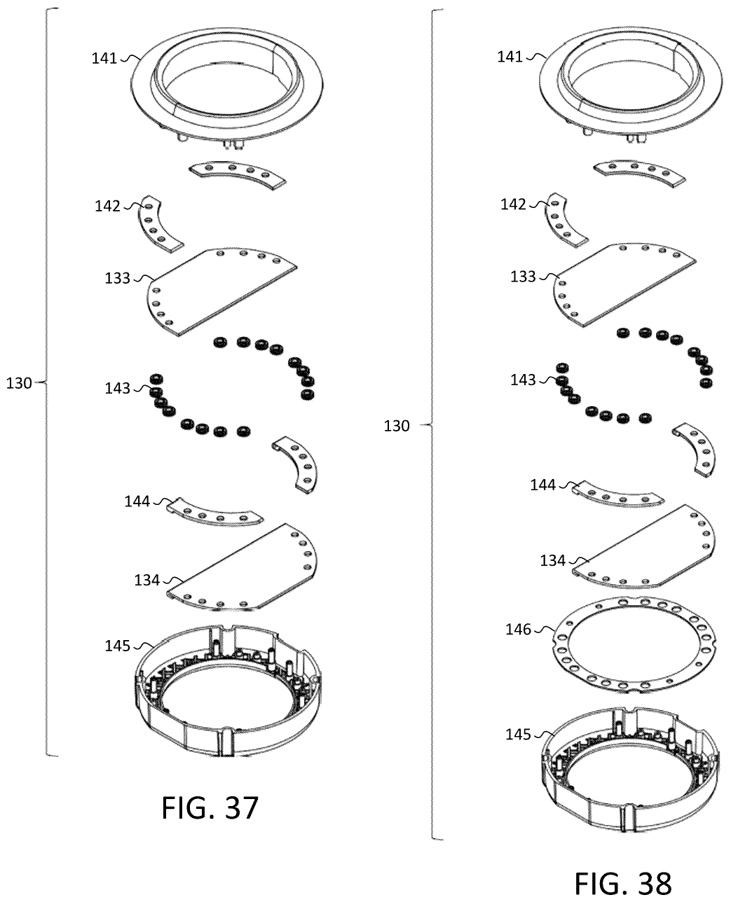

FIGS. 37 and 38 show top exploded views of the components of two different embodiments of the third lid cartridge 130. A top portion 141 includes both the outer rim 131 and vertical wall 132 (see FIGS. 31, 33). A bottom portion 145 serves as the base to the third lid cartridge 130. The top portion 141 and bottom portion 145 sandwich the third lid cartridge 130 and keep all of the components held together through use of securing devices 143, such as bolts, screws, ties, or the like. A first planar sheet 133 and second planar sheet 134 are connected by top and bottom quarter arcs 142, 144, respectively, on the circular outer edge of the semi-circle planar sheets 133, 134. The quarter arcs 142, 144 serve to secure the outer edges of the planar sheets 133, 134 by locking them in place within the third lid cartridge 130. Each of these components may be taken out and replaced as needed. The embodiment shown in FIG. 38 has an optional additional locking ring 146 that is positioned directly above the bottom portion 145 and further secures the bottom edge of the planar sheets 133, 134.

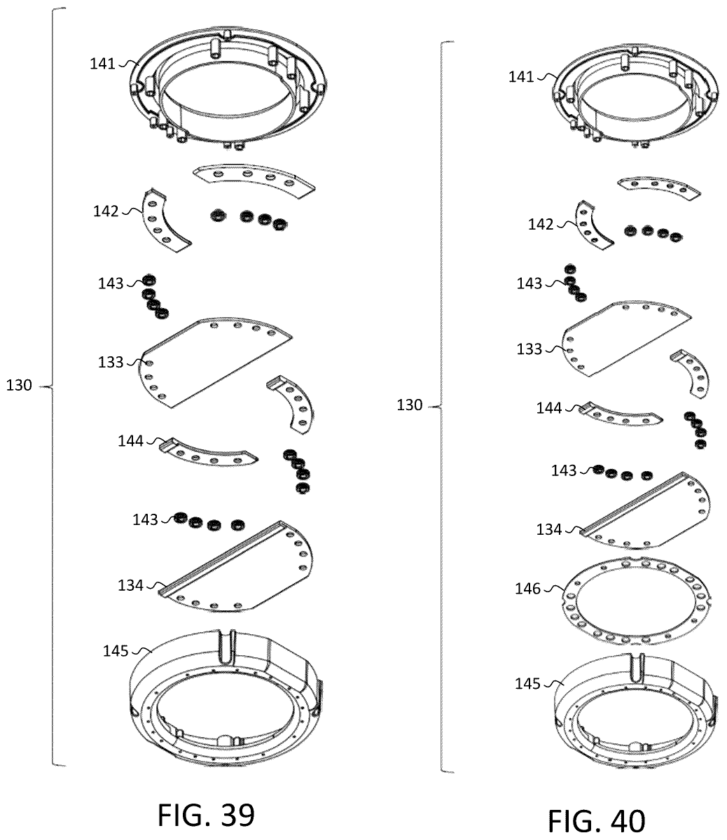

FIGS. 39 and 40 show bottom exploded views of the components of two different embodiments of the third lid cartridge 130. It should be noted that that the embodiments shown in FIGS. 37-40 show two sets of 8 attachment devices 143 on each side of the planar sheets 133, 134, but any number is possible.

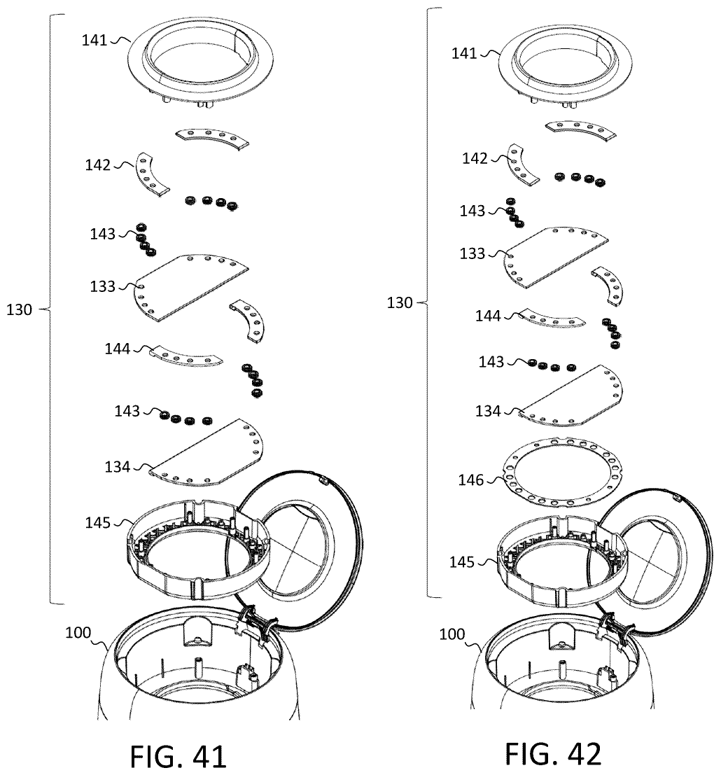

FIGS. 41 and 42 show top exploded views of the components of two different embodiments of the third lid cartridge 130 positioned upon a top portion of a container 100, with first lid 111 and second lid 120 lifted upwards.

Various materials may be used for the third lid cartridge 130 and the components within. For example, planar sheets 133 and 134 may be elastic material with identifying colors, such as PANTONE 14-5707 TCX and PANTONE 16-5907 TCX, respectively. The planar sheets 133, 134 may be a durable and pliable material, such as NYLON or the like. Any combination may be used as long as the characteristics of the combination of the planar sheets produce the function and result as shown and described herein.

The quarter arcs 142, 144 may be elastic, plastic, metal or other material. Each of the quarter arcs 142, 144 may be individually used or combined into a semi-circle or full circle. The top portion 141 and bottom portion 145 may be glass filled PA66 or similar material. The optional ring 146 may be metallic, plastic, or other material.

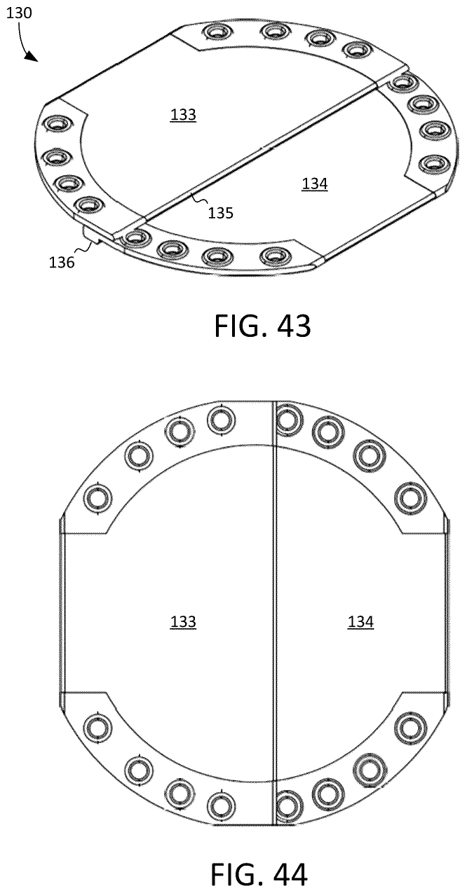

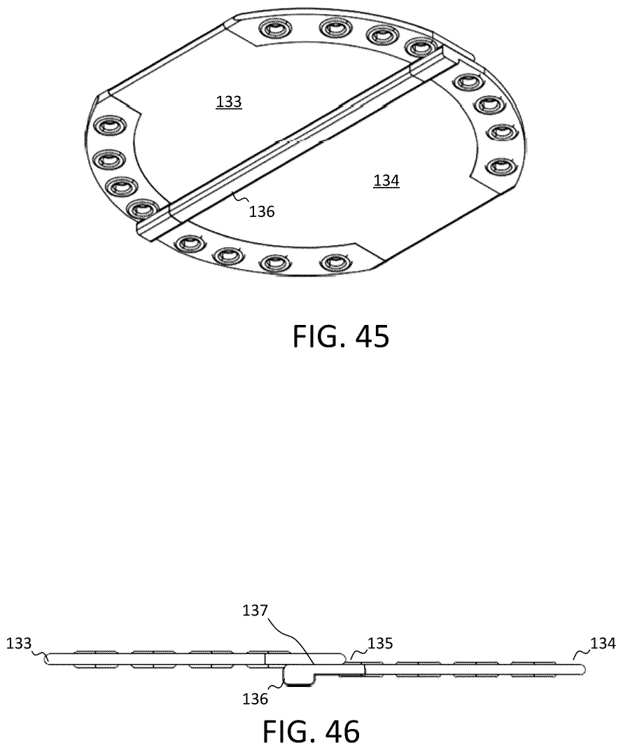

As shown in the isolated views in FIGS. 43-46, and as shown positioned within the third lid cartridge 130 in the cross-sectional views of FIGS. 35-36, the planar sheets 133 and 134 are discontinuous such that the top surface of planar sheet 133 is positioned higher than the top surface of planar sheet 134. Additionally, as shown in the figures (see FIG. 46), the right most end of the higher positioned planar sheet 133 ends at a position which is to the right of the left most end of the lowered position planar sheet 134. The end point of the planar sheet 133 creates a linear gap 135 which creates an area of overlap 137 between planar sheet 133 and planar sheet 134, and spans and acts as a chord across the circular section created by the vertical wall 132. See, for example FIG. 34. In this figure, the linear gap 135 is shown to be to the right of the vertical diameter which would run from the 6 to the 12 o'clock position on the circular planar sheet assembly 133, 134. This is so that the overlapped area 137 (shown in FIG. 46) would be maximized, therefore allowing a great area to push soiled diaper therethrough.

Further, as shown in FIG. 35, planar sheet 134 folds over to create a U-shaped left most end 136, positioned underneath and to the left of the right end (at 135) of the planar sheet 133. This U-shaped end 136 allows bags to be positioned and secured within the linear gap 135, as will be shown and discussed in further detail below. A downward push of the bag through linear gap 135 creates a contact with the U-shaped curve 136 such that any upward motion in the bag would be resisted by the end of the U-shaped curve 136, which would contact the surface of the bag. This would allow for unidirectional (downward) movement of the bag through gap 135.

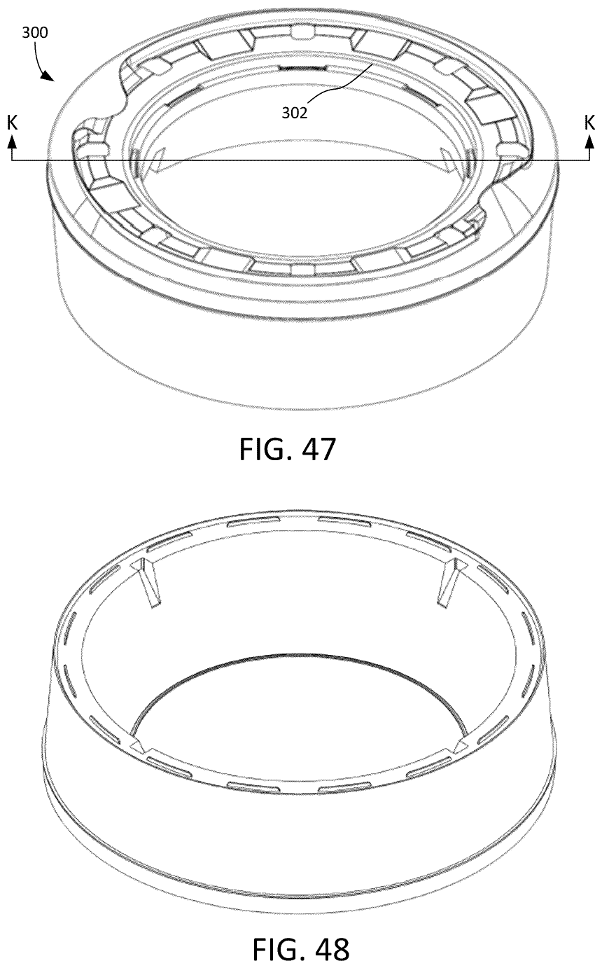

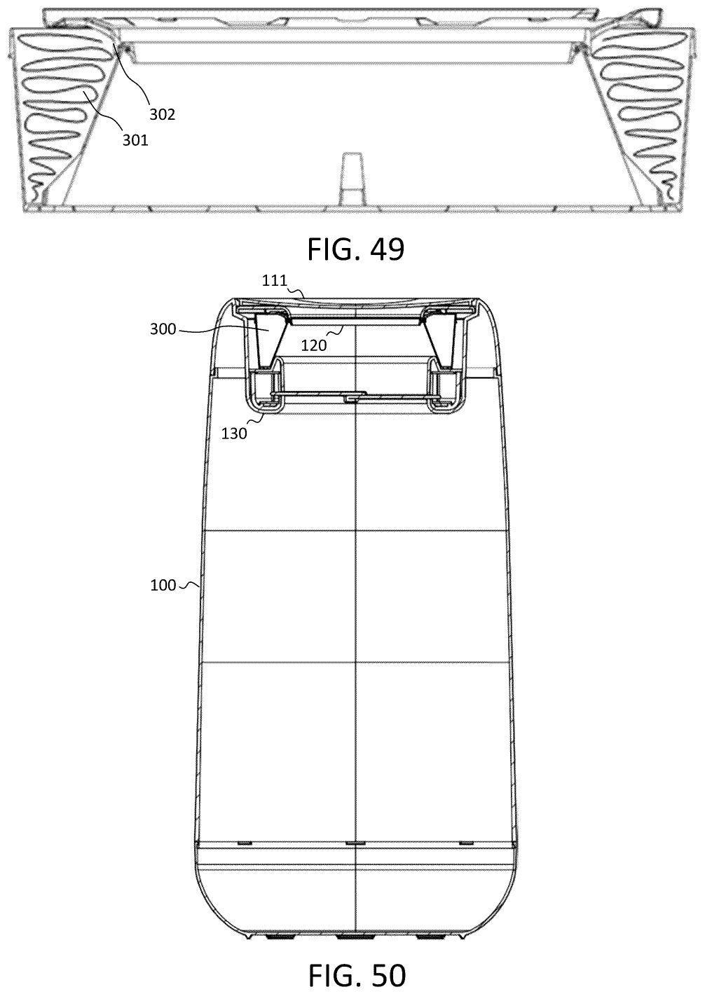

FIGS. 47-50 show various views of a cassette 300 according to the present subject disclosure. FIG. 47 shows a top perspective view and FIG. 48 shows a bottom perspective view of the cassette 300 which houses a roll or sheet of material 301 to be pulled out and used as a disposable bag within container 100. FIG. 49 shows a cross-sectional view of the cassette 300 along plane K-K of FIG. 47. FIG. 50 shows a cross-sectional view of a container 100 housing a cassette 300. A stack or rolled sheet of material 301 is positioned on the peripheral outer edge of the cassette 300 which is then pulled out through a circular crevice 302 and directed into the middle portion of the cassette 300 and through the third lid cartridge 130.

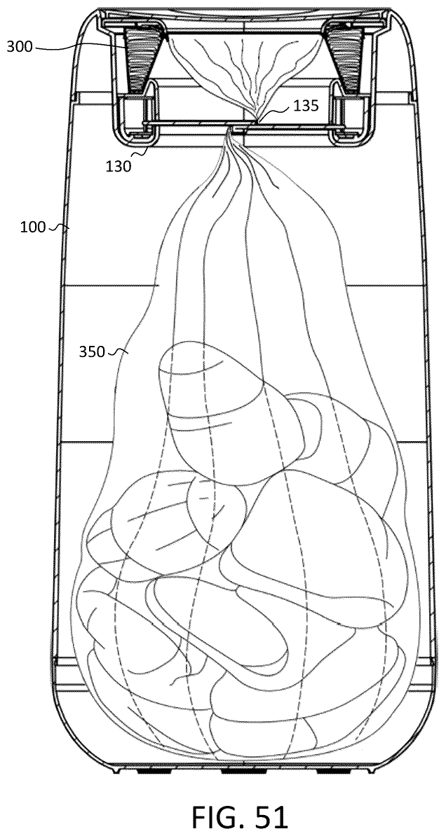

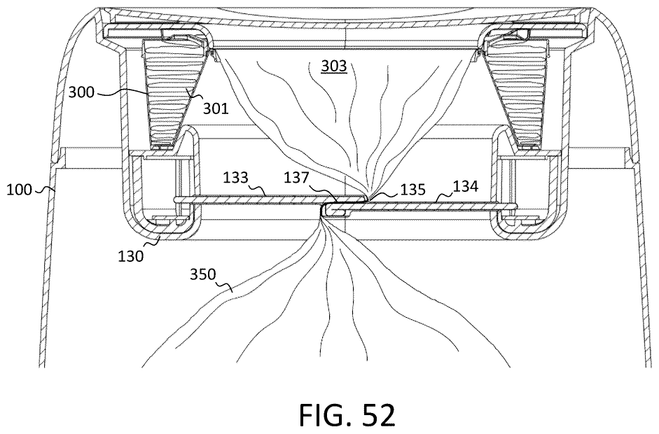

FIGS. 51 and 52 show cross-sectional views of a cassette 300 in use within a container 100, according to the present subject disclosure. FIG. 52 shows a more detailed view of the cassette 300 positioned atop the third lid cartridge 130 with a rolled or stacked material 301 which has been pulled through and pushed within the linear gap 135. A user places a soiled diaper into the open top portion of the bag 303 and pushes down so that the soiled diaper is pushed through the opened linear gap 135, which then separates the overlapped contact area 137 formed between the two planar sheets 133, 134. Once the soiled material pushes through the overlapped contact area 137, it drops into the open bag 350. When the soiled diaper has cleared the overlapped contact area 137, the planar surfaces 133, 134 make close contact again in the contact area 137, and gap 135 closes up so that the portion of the bag between the open bag 303 and the bottom bag 350 is sandwiched together between the two overlapping surfaces 133, 134. The odor and harmful contents inside the bag 350 are therefore maintained within the bag 350 and not allowed to seep through to the open end 303.

FIGS. 53 and 54 show cross-sectional views of a single use bag 400 in use within a container 100, according to the present subject disclosure. FIG. 54 shows a more detailed view of the single use bag 400 having an attachment frame 401 which is positioned atop the third lid cartridge 130 with a bag that has been pulled through and pushed within the linear gap 135. A user places a soiled diaper into the open top portion of the bag 403 and pushes down so that the soiled diaper is pushed through the opened linear gap 135, which then separates the overlapped contact area 137 formed between the two planar sheets 133, 134. Once the soiled material pushes through the overlapped contact area 137, it drops into the open bag 450. When the soiled diaper has cleared the overlapped contact area 137, the planar surfaces 133, 134 make close contact again in the contact area 137, and gap 135 closes up so that the portion of the bag between the open bag 403 and the bottom bag 450 is sandwiched together between the two overlapping surfaces 133, 134. The odor and harmful contents inside the bag 450 are therefore maintained within the bag 450 and not allowed to seep through to the open end 403.

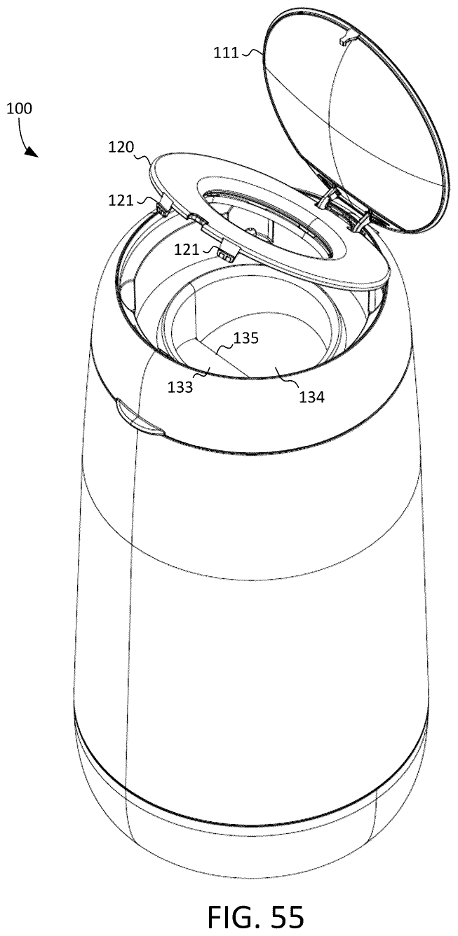

The exemplary embodiment shown in FIGS. 55-58 is substantially similar to the embodiments shown in the prior examples, with some alternate features, each of which may be individually or collectively substituted with the features shown and described in the other embodiments already presented in this specification. The same features, which were already discussed above, will not be repeated again, for sake of simplicity and clarity.

FIG. 55 shows a perspective view of container 100 with a raised first lid 111 and a partially raised second lid 120, according to another exemplary embodiment of the present subject disclosure.

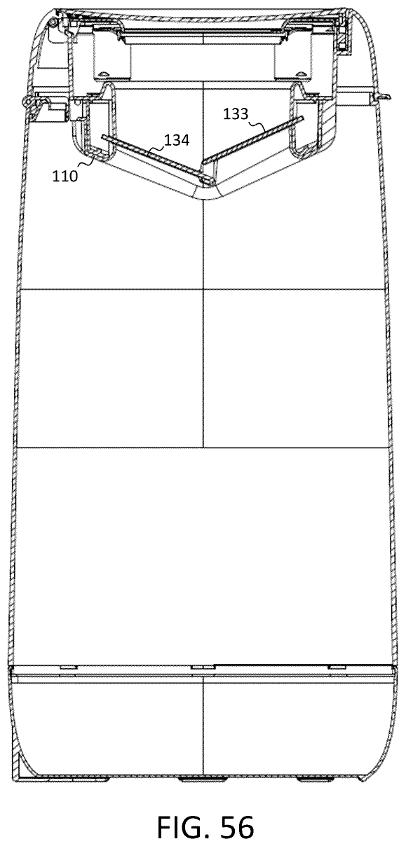

FIG. 56 shows a cross-sectional view of container 100 of FIG. 55 similar to plane A-A of the top view shown in FIG. 7. As shown in FIG. 56, container 100 includes a lid assembly 110 having three separate and independent lids, each pivotably independent, and a pair of parallel planar surfaces 133, 134, similar to that described above with respect to container 100 of FIG. 6 and elsewhere.

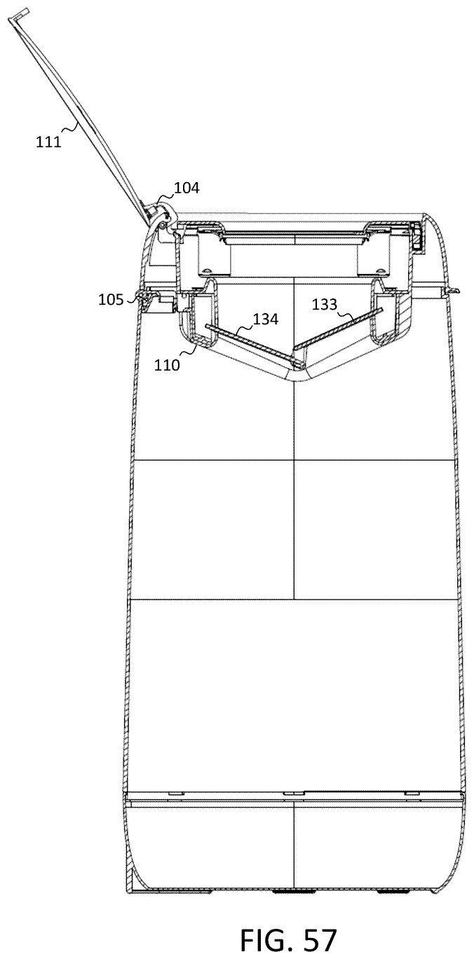

FIG. 57 shows a cross-sectional view of container 100 of FIG. 55 similar to plane C-C of the top view shown FIG. 13, with a raised first lid 211. As shown in FIG. 57, internal hinge 104 is positioned inside container 100 and allows the rotation of the first lid 111, and external hinge 105 is positioned mostly on the outside of container 100 and allows the rotation of the lid assembly 110 as a whole.

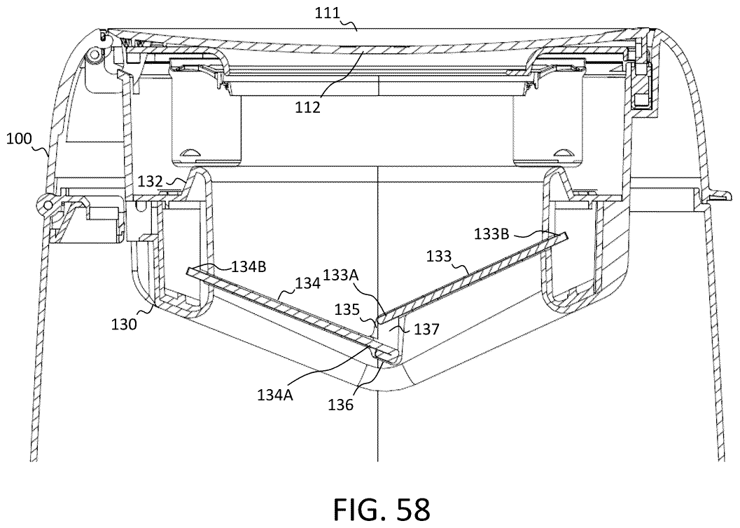

FIG. 58 shows a cross-sectional view of third lid cartridge 130 within container 100. Similar to that shown in FIG. 36, a bottom portion of a cassette 300 may be positioned atop the outer rim 131 of the third lid cartridge 130. Further, an inner sloped wall 301 of a cassette 300 is angled such that its bottom portion mates with the outer angled portion of the vertical wall 132 of the third lid cartridge 130. The inner sloped wall 301 of a cassette 300 encircles and slides upon the outer angled portion of vertical wall 132. This contact creates secure and stable cradling of the cassette 300 between the second lid 112 and third lid cartridge 130, as shown in FIG. 36.

FIGS. 55-58 show cross-sectional views of a container 100, according to another exemplary embodiment of the present subject disclosure. Similar to the embodiments and description provided for FIGS. 52 and 54, FIG. 58 shows a more detailed view of the potential position of a cassette 300 or a single use bag 400 positioned atop the third lid cartridge 130 with a rolled or stacked material which has been pulled through and pushed within the linear gap 135. A user places a soiled diaper into the open top portion of the bag 303 of the cassette 300 or top opening of the single use bag 400 and pushes down so that the soiled diaper is pushed through the opened linear gap 135, which then separates the overlapped contact area 137 formed between the two planar sheets 133, 134. Once the soiled material pushes through the overlapped contact area 137, it drops into the open bag. When the soiled diaper has cleared the overlapped contact area 137, the planar surfaces 133, 134 make closer contact again in the contact area 137, and gap 135 closes up so that the portion of the bag above and below the overlapping planar surfaces 133, 134 is sandwiched together between the two overlapping surfaces 133, 134. The odor and harmful contents inside the bag below the overlapping planar surfaces 133, 134 are therefore maintained within the lower portion of the bag and not allowed to seep through to the open end.

As previously mentioned, the exemplary embodiment shown in FIGS. 55-58 is substantially similar to the embodiments shown in the prior examples, with some alternate features, each of which may be individually or collectively substituted with the features shown in the other embodiments of this specification. As shown in FIG. 55, one or more clips 121 positioned on the second lid 120 reversibly snap into a complementary portion of the third lid cartridge 130. Clips 121 are designed to firmly attach the second lid 120 to the third lid cartridge 130 with a press fit that attaches the two components together, and a press fit release.

As shown best in FIG. 58, the overlapping planar surfaces 133, 134 shown in the embodiments of FIGS. 55-58 are positioned at a skewed angle to each other, in contrast with the substantially parallel configuration of the prior described exemplary embodiments. The planar surface 133 has an inner end 133A and an outer end 133B, and planar surface 134 has an inner end 134A and an outer end 134B. Inner ends 133A and 134A overlap in an overlapping area 137. The overlapping area 137 forms a chamber with a gap 135 between the outer end 133A and a top surface of the planar surface 134. The downward slope position of the planar surfaces 133, 134 in this embodiment allows an easier downflow and movement of materials placed within the container 100. The downward slope, along with gravity, work together to provide an easier placement and downward unidirectional movement of materials placed therein. The skewed angle or downward slope position of the planar surfaces 133, 134 relative to each other is also beneficial when pushing materials through the downwardly angled overlapping area 137 and into the bag portion disposed below within the container 100.

As shown best in FIG. 55, gap 135 is positioned such that it is horizontal with respect to a top-down surface view from the front of the container 100. This horizontal position of the gap 135 further assists in the ease of placing materials within the container 100, as it more matches the horizontal position of a user's knuckles, hand and fist as the user places an item between the two overlapping planar surfaces 133, 134.

The illustrations and examples provided herein are for explanatory purposes and are not intended to limit the scope of the appended claims. It will be recognized by those skilled in the art that changes, or modifications may be made to the above-described embodiments without departing from the broad inventive concepts of the invention. It is understood therefore that the invention is not limited to the particular embodiments which are described but is intended to cover all modifications and changes within the scope and spirit of the subject disclosure.

The foregoing disclosure of the exemplary embodiments of the present subject disclosure has been presented for purposes of illustration and description. It is not intended to be exhaustive or to limit the subject disclosure to the precise forms disclosed. Many variations and modifications of the embodiments described herein will be apparent to one of ordinary skill in the art in light of the above disclosure. The scope of the subject disclosure is to be defined only by the claims appended hereto, and by their equivalents.

Further, in describing representative embodiments of the present subject disclosure, the specification may have presented the method and/or process of the present subject disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present subject disclosure should not be limited to the performance of their steps in the order written, and one skilled in the art can readily appreciate that the sequences may be varied and still remain within the spirit and scope of the present subject disclosure.

What is claimed:

1. A diaper pail, comprising:
a housing; and
a lid assembly attached to the housing, the lid assembly having:
a first lid that allows access to an interior of a flexible bag assembly housed within the housing;
a second lid that allows access to a top structure of the flexible bag assembly housed within the housing;
a third lid cartridge that accommodates the flexible bag assembly; and
a pair of planar sheets that overlap with each other and pinch a portion of a bag formed by the flexible bag assembly.

2. The diaper pail of claim 1, wherein the flexible bag assembly comprises a single use flexible bag having an attachment frame.

3. The diaper pail of claim 2, wherein the attachment frame is secured to the third lid cartridge.

4. The diaper pail of claim 1, wherein the flexible bag assembly comprises a cassette adapted to dispense a flexible tubing.

5. The diaper pail of claim 4, wherein the cassette is secured to the third lid cartridge.

6. The diaper pail of claim 1, wherein the second lid and the third lid cartridge both have a central opening.

7. The diaper pail of claim 1, wherein the lid assembly rotates about a first hinge attached to the housing.

8. The diaper pail of claim 7, wherein the first lid and the second lid rotate about a second hinge attached to an upper end of the lid assembly.

9. The diaper pail of claim 1, wherein the pair of planar sheets that overlap are positioned at a skewed angle relative to each other.

10. The diaper pail of claim 1, wherein the pair of planar sheets are secured by an outer circular frame.

11. The diaper pail of claim 10, wherein the outer circular frame is positioned in the third lid cartridge.

12. The diaper pail of claim 10, wherein the pair of planar sheets are composed of elastic material.

13. The diaper pail of claim 10, further comprising a linear gap which is formed by the overlap of one of the planar sheets over the other planar sheet.

14. The diaper pail of claim 13, wherein the linear gap is a chord which extends from one point on the circular frame to another point on the circular frame, the chord not being a diameter of the circular frame.

15. The diaper pail of claim 10, wherein one of the planar sheets is positioned lower than the other planar sheet.

16. The diaper pail of claim 15, wherein the lower planar sheet has a U-shaped end that curves to an underside of the lower surface of the lower planar sheet.

17. The diaper pail of claim 16, further comprising an overlap area between the first planar sheet and the second planar sheet, the overlap area being separable to allow passage of the bag therethrough.

18. The diaper pail of claim 17, wherein the U-shaped end of the lower planar sheet is positioned underneath the overlap area between the first planar sheet and the second planar sheet.

19. A diaper pail, comprising:
a housing having an upper end and a lower end; and
a lid assembly attached to the upper end, the lid assembly having:
a first lid that allows access to an interior of a flexible bag assembly housed within the housing;
a second lid that is pivotally attached to the first lid by a second hinge and allows access to a top structure of the flexible bag assembly housed within the housing;
a third lid cartridge that accommodates the flexible bag assembly; and
a pair of planar sheets secured in a circular frame positioned within the third lid cartridge, such that the planar sheets overlap with each other and pinch a portion of a bag formed by the flexible bag assembly.

20. A diaper pail, comprising:
a housing having an upper end and a lower end; and
a lid assembly attached by a first hinge to the upper end, the lid assembly having:
a first lid that allows access to an interior of a flexible bag assembly housed within the housing;
a second lid that is pivotally attached to the first lid by a hinge and allows access to a top structure of the flexible bag assembly housed within the housing;
a third lid cartridge that accommodates the flexible bag assembly; and
a pair of planar sheets positioned within the third lid cartridge that overlap with each other such that one of the planar sheets is partially positioned below the other planar sheet such that the planar sheets pinch a portion of a bag formed by the flexible bag assembly.
